(19) United States
(12) Patent Application Publication
(10) Pub. No.: US 2025/0069181 A1
(43) Pub. Date: Feb. 27, 2025

(54) PROCESSING PERFORMANCE THROUGH HARDWARE AGGREGATION OF ATOMIC OPERATIONS

(71) Applicant: QUALCOMM Incorporated, San Diego, CA (US)

(72) Inventors: Tao WANG, Sunnyvale, CA (US); Jing HAN, San Jose, CA (US); Yun LI, San Jose, CA (US); Fei XU, San Jose, CA (US)

(21) Appl. No.: 18/456,083

(22) Filed: Aug. 25, 2023

(51) Int. Cl. G06T 1/20; G06F 9/48; G06T 1/60

(52) U.S. Cl. CPC G06T 1/20; G06F 9/48; G06T 1/60

(57) ABSTRACT

Aspects of the disclosure are directed to information processing. In accordance with one aspect, information processing includes a databus; a memory system coupled to the databus; and a graphics processing unit (GPU) coupled to the memory system and the databus, wherein the GPU is configured to do the following: retrieve a first plurality of atomic operations containing a first plurality of data values for a shared memory location; compute a first aggregate data value based on the first plurality of data values; and generate a first aggregate atomic operation containing the first aggregate data value.

### TECHNICAL FIELD

This disclosure relates generally to the field of information processing, and, in particular, to processing performance through hardware aggregation of atomic operations.

### BACKGROUND

Many information processing systems include multiple processing engines, processors or processing cores for increasingly demanding user applications. Information processing systems may include a central processing unit (CPU), a graphics processing unit (GPU), a digital signal processor (DSP), an image signal processor (ISP), a neural processing unit (NPU), etc., along with input/output interfaces, a hierarchy of memory units and associated interconnection databuses. In many applications, the information processing system is assigned to work on a plurality of atomic operations which may be executed on a plurality of processing engines. However, performance may be compromised by inefficient shared memory access for atomic operations by the plurality of processing engines. For such information processing systems, performance may be attained by efficient hardware execution of atomic operations with multiple processing engines and a shared memory.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides processing performance through hardware aggregation of atomic operations Accordingly, an apparatus for implementing information processing, the apparatus including a databus; a memory system coupled to the databus; and a graphics processing unit (GPU) coupled to the memory system and the databus, wherein the GPU is configured to do the following: retrieve a first plurality of atomic operations containing a first plurality of data values for a shared memory location; compute a first aggregate data value based on the first plurality of data values; and generate a first aggregate atomic operation containing the first aggregate data value.

In one example, the GPU includes an aggregator, wherein the aggregator is configured to compute the first aggregate data value and to generate the first aggregate atomic operation. In one example, the GPU is further configured to execute the first aggregate atomic operation containing the first aggregate data value by modifying the shared memory location. In one example, the GPU is further configured to receive a first return data value from the execution of the first aggregate atomic operation with data return. In one example, the GPU is further configured to successively offset the first return data value to generate a first plurality of offsetted return data values.

In one example, the apparatus further includes a display processing unit (DPU) coupled to the databus; and a video display coupled to the DPU and the databus, wherein the video display is configured to display the first return data value and/or the first plurality of offsetted return data values. In one example, the GPU includes an aggregator, wherein the aggregator is configured to compute the first aggregate data value and to generate the first aggregate atomic operation.

In one example, the GPU is further configured to: retrieve a second plurality of atomic operations containing a second plurality of data values for the shared memory location; compute a second aggregate data value based on the second plurality of data values; and generate a second aggregate atomic operation containing the second aggregate data value.

In one example, the GPU is further configured to: receive a second return data value from the executing of the second aggregate atomic operation with data return; and successively offset the second return data value to generate a second plurality of offsetted return data values. In one example, the memory system comprises a memory unit and a cache memory.

Another aspect of the disclosure provides a method for implementing information processing. the method including: retrieving a first plurality of atomic operations containing a first plurality of data values for a shared memory location; computing a first aggregate data value based on the first plurality of data values; and generating a first aggregate atomic operation containing the first aggregate data value.

In one example, the method further includes retrieving a second plurality of atomic operations containing a second plurality of data values for the shared memory location. In one example, the method further includes computing a second aggregate data value based on the second plurality of data values. In one example, the method further includes generating a second aggregate atomic operation containing the second aggregate data value.

In one example, the method further includes executing the first aggregate atomic operation containing the first aggregate data value by modifying the shared memory location. In one example, the method further includes executing the second aggregate atomic operation containing the second aggregate data value by modifying the shared memory location.

In one example, the method further includes receiving a first return data value from the executing of the first aggregate atomic operation with data return. In one example, the method further includes successively offsetting the first return data value to generate a first plurality of offsetted return data values. In one example, the method further includes receiving a second return data value from the executing of the second aggregate atomic operation with data return. In one example, the method further includes successively offsetting the second return data value to generate a second plurality of offsetted return data values.

In one example, the method further includes executing the first aggregate atomic operation containing the first aggregate data value by modifying the shared memory location. In one example, the method further includes receiving a first return data value from the execution of the first aggregate atomic operation with data return. In one example, the method further includes successively offsetting the first return data value to generate a first plurality of offsetted return data values.

Another aspect of the disclosure provides an apparatus for information processing, the apparatus including: means for retrieving a first plurality of atomic operations containing a first plurality of data values for a shared memory location; means for computing a first aggregate data value based on the first plurality of data values; and means for generating a first aggregate atomic operation containing the first aggregate data value.

In one example, the apparatus further includes: means for retrieving a second plurality of atomic operations containing a second plurality of data values for the shared memory location; means for computing a second aggregate data value based on the second plurality of data values; and means for generating a second aggregate atomic operation containing the second aggregate data value.

In one example, the apparatus further includes: means for executing the first aggregate atomic operation containing the first aggregate data value by modifying the shared memory location; and means for executing the second aggregate atomic operation containing the second aggregate data value by modifying the shared memory location.

In one example, the apparatus further includes: means for receiving a first return data value from the executing of the first aggregate atomic operation with data return; and means for successively offsetting the first return data value to generate a first plurality of offsetted return data values.

In one example, the apparatus further includes: means for receiving a second return data value from the executing of the second aggregate atomic operation with data return; and means for successively offsetting the second return data value to generate a second plurality of offsetted return data values.

Another aspect of the disclosure provides a non-transitory computer-readable medium storing computer executable code, operable on a device including at least one processor and at least one memory coupled to the at least one processor, wherein the at least one processor is configured to implement information processing, the computer executable code including: instructions for causing a computer to retrieve a first plurality of atomic operations containing a first plurality of data values for a shared memory location; instructions for causing the computer to compute a first aggregate data value based on the first plurality of data values; and instructions for causing the computer to generate a first aggregate atomic operation containing the first aggregate data value.

In one example, the non-transitory computer-readable medium further includes instructions for causing the computer to: execute the first aggregate atomic operation containing the first aggregate data value by modifying the shared memory location; receive a first return data value from the execution of the first aggregate atomic operation with data return; and successively offset the first return data value to generate a first plurality of offsetted return data values.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example of an information processing system.

FIG. 2 illustrates examples of atomic operations without data returns.

FIG. 3 illustrates examples of atomic operations with data returns.

FIG. 4 illustrates a first example solution for atomic operations without data return.

FIG. 5 illustrates a second example solution for atomic operations without data return.

FIG. 6 illustrates a first example solution for atomic operations with data return.

FIG. 7 illustrates a second example solution for atomic operations with data return.

FIG. 8 illustrates an example flow diagram for atomic operations without data return.

FIG. 9 illustrates an example flow diagram for atomic operations with data return.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

An information processing system, for example, a computing system with multiple slices (e.g., processing engines) or a system on a chip (SoC), requires multiple levels of coordination or synchronization. In one example, a slice includes a processing engine (i.e., a subset of the computing system) as well as associated memory units and other peripheral units. In one example, execution of an application may be decomposed into a plurality of work tasks which are executed by multiple slices or multiple processing engines.

In one example, the associated memory units of the information processing system may form a memory hierarchy with a local memory unit or an internal cache memory unit dedicated to each slice, a global memory unit shared among all slices and other memory units with various degrees of shared access. For example, a first level cache memory or L1 cache memory may be a memory unit dedicated to a single processing engine and may be optimized with a faster memory access time at the expense of storage space. For example, a second level cache memory or L2 cache memory may be a memory unit which is shared among more than one processing engine and may be optimized to provide a larger storage space at the expense of memory access time. In one example, each slice or each processing engine includes a dedicated internal cache memory.

In one example, the memory hierarchy may be organized as a cascade of cache memory units with the first level cache memory, the second level cache memory and other memory units with increasing storage space and slower memory access time going up the memory hierarchy. In one example, other cache memory units in the memory hierarchy may be introduced which are intermediate between existing memory units. For example, an L1.5 cache memory, which is intermediate between the L1 cache memory and the L2 cache memory, may be introduced in the memory hierarchy of the information processing system.

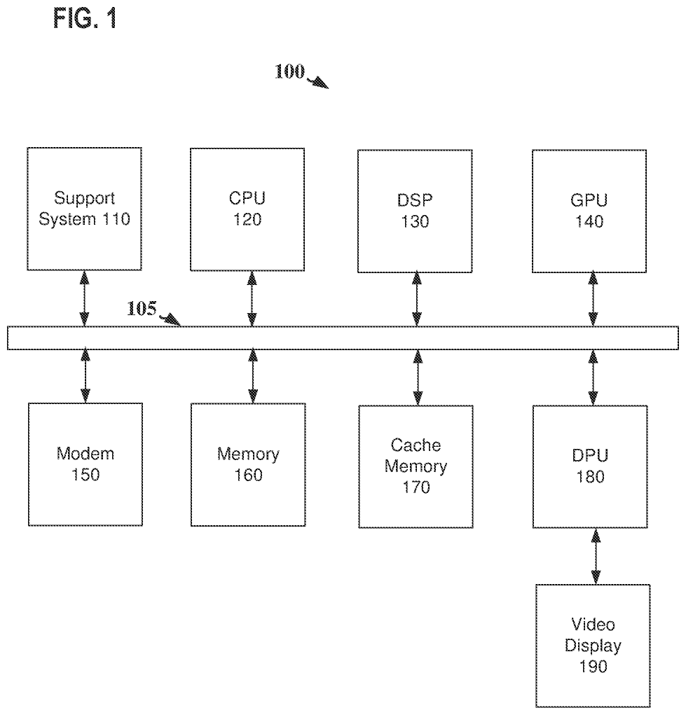

FIG. 1 illustrates an example of an information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. In one example, modem 150 is an input/output device to external entities. For example, modem 150 receives data from one or more component of the information processing system 100 and sends the data to an external entity. For example, the plurality of processing engines and various other functions may be interconnected by an interconnection databus 105 to transport data and control information. For example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines.

One technique used in an information processing system is parallel processing, that is, processing of a plurality of threads in parallel among a plurality of processing engines. A thread is a group of logically connected processing tasks. Parallel processing of the plurality of threads may involve both internal (i.e., dedicated) memory and shared memory. In one example, execution of the plurality of threads is initiated by the plurality of processing engines and includes read operations into shared memory and write operations into shared memory. In one example, read operations retrieve data from shared memory locations and write operations store data into shared memory. One skilled in the art would understand that the term “shared memory” as disclosed herein may include global memory and local memory.

In one example, parallel processing of the plurality of threads using shared memory, such as the memory 160 and/or the cache memory 170, among the plurality of processing engines requires a deconfliction mechanism to avoid data collisions (i.e., contention among different processing engines for the same data). In one example, one technique used to avoid data collisions with parallel processing is through the usage of atomic operations. In one example, an atomic operation is a sequence of processor instructions by one processing engine which access a shared memory location, for both read and write operations, without any conflict from any other processing engine. That is, for example, the atomic operation ensures that no data collision may occur since memory access is regulated such that one and only one processing engine may access the shared memory location during an execution time interval associated with the atomic operation.

In one example, although execution of the atomic operation avoids data collisions, its serialized nature effectively slows down overall information processing system speed. That is, atomic operations are intrinsically sequential in nature. Therefore, a plurality of atomic operations to a shared memory location may be serialized to avoid data collisions. For example, the plurality of processing engines may execute the plurality of threads in parallel. In one example, when the plurality of atomic operations from the plurality of threads needs to access the shared memory location (e.g., atomic_max (addressA, value)), each atomic operation from the plurality of atomic operations may need to be executed sequentially, without parallelism, which may result in degraded performance (e.g., lower throughput).

In one example, an execution of a plurality of atomic operations to a shared memory location aggregates the plurality of atomic operations in hardware prior to sending the plurality of atomic operations to shared memory. For example, the execution may be performed for two classes of processor operations: atomic operations without data returns and atomic operations with data returns. In one example, atomic operations without data returns are atomic operations which do not require data from shared memory to be sent back to the plurality of processing engines. In one example, atomic operations with data returns are atomic operations which do require data from shared memory to be sent back to the plurality of processing engines.

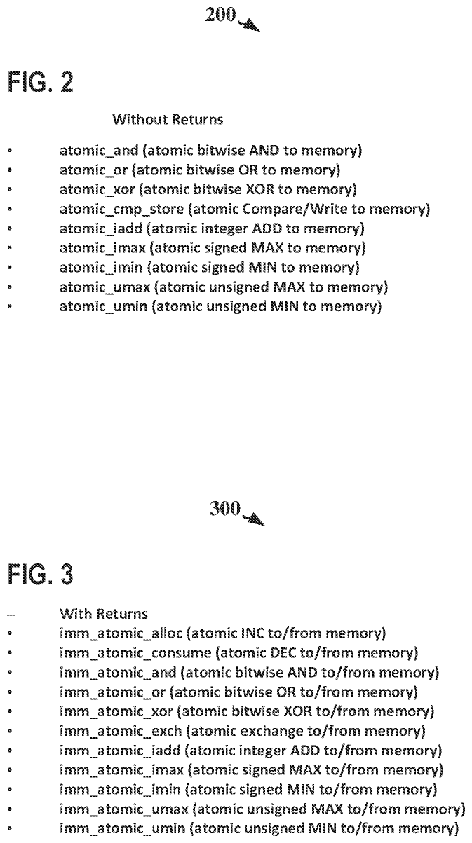

FIG. 2 illustrates examples of atomic operations without data returns 200. In one example, in these atomic operations (e.g., bitwise logical operations, write operations to shared memory, etc.), data from shared memory does not need to be sent back to the plurality of processing engines.

FIG. 3 illustrates examples of atomic operations with data returns 300. In one example, in these atomic operations (e.g., read and write operations to shared memory, etc.), data from shared memory is sent back to the plurality of processing engines.

In one example, atomic operations without data return which need to access a shared memory location (i.e., target to the same memory address) may aggregate a plurality of atomic operations. In one example, aggregation of atomic operations replaces a plurality of atomic operations with a single aggregate atomic operation. In one example, the aggregation is performed in hardware prior to a shared memory access operation. In one example, if there are four threads which would retrieve the following four atomic operations to shared memory,
Atomic_max (addressA, value0)
Atomic_max (addressA, value1)
Atomic_max (addressA, value2)
Atomic_max (addressA, value3),
   the plurality of processing engines (i.e., the hardware) may instead compute, a priori, a maximum value denoted by
newValue=max (value0, value1, value2, value3) and then issue a single aggregate atomic operation to shared memory:
Atomic_max (addressA, newValue).

In this example, the quantity of atomic operations is reduced from four to one.

In one example, atomic operations with data return which need to access a shared memory location (i.e., target to the same memory address) may aggregate a plurality of atomic operations. For example, aggregation of atomic operations may replace a plurality of atomic operations with a single aggregate atomic operation. In one example, the aggregation is performed in hardware prior to a shared memory access operation. In one example, if there are two atomic operations with data returns:
Imm_atomic_alloc (atomic_inc)
Imm_atomic_consume (atomic_dec),

and if there are four threads issuing:
Atomic_inc (addressA)
Atomic_inc (addressA)
Atomic_inc (addressA)
Atomic_inc (addressA),

the plurality of processing engines (i.e., the hardware) may instead aggregate these two atomic operations and then issue a single aggregate atomic operation to shared memory:
Imm_atomic_add (addressA,4).

In this example, when a value K is returned from shared memory, the values K, K+1, K+2, K+3 may be assigned to the four threads.

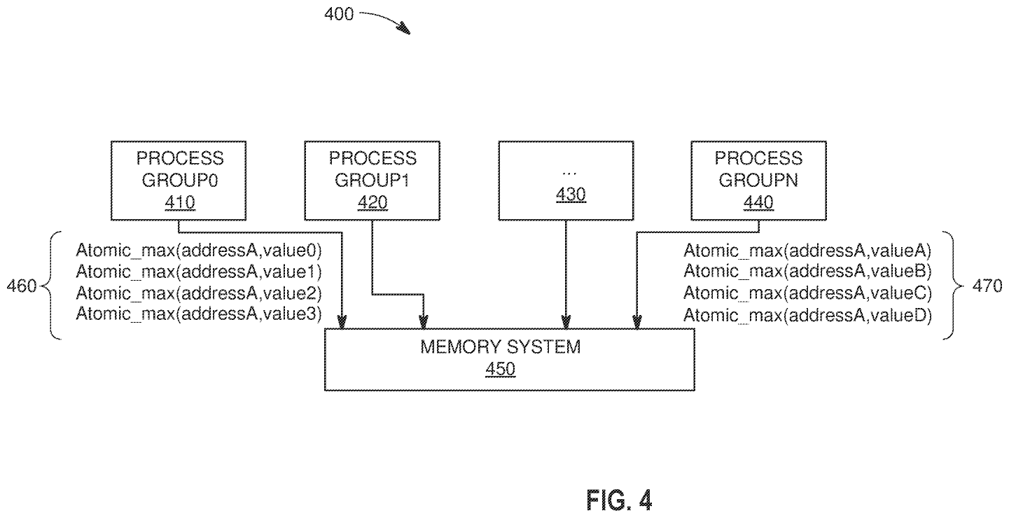

FIG. 4 illustrates a first example solution for atomic operations without data return 400. In one example, a first processing engine 410, a second processing engine 420, a third processing engine 430 and a fourth processing engine 440 access a shared memory 450. In one example, the first processing engine 410 executes a first plurality of atomic operations without data return 460. In one example, the fourth processing engine 440 executes a second plurality of atomic operations without data return 470. In this example, the first plurality of atomic operations needs to access a same shared memory location (i.e., addressA) such that individual atomic operations of the first plurality of atomic operations need to avoid a data collision and thus operate in a serialized manner which results in a performance bottleneck (i.e., slower performance). In this example, the second plurality of atomic operations needs to access the same shared memory location (i.e., addressA) such that individual atomic operations of the second plurality of atomic operations need to avoid a data collision and thus operate in a serialized manner which also results in a performance bottleneck.

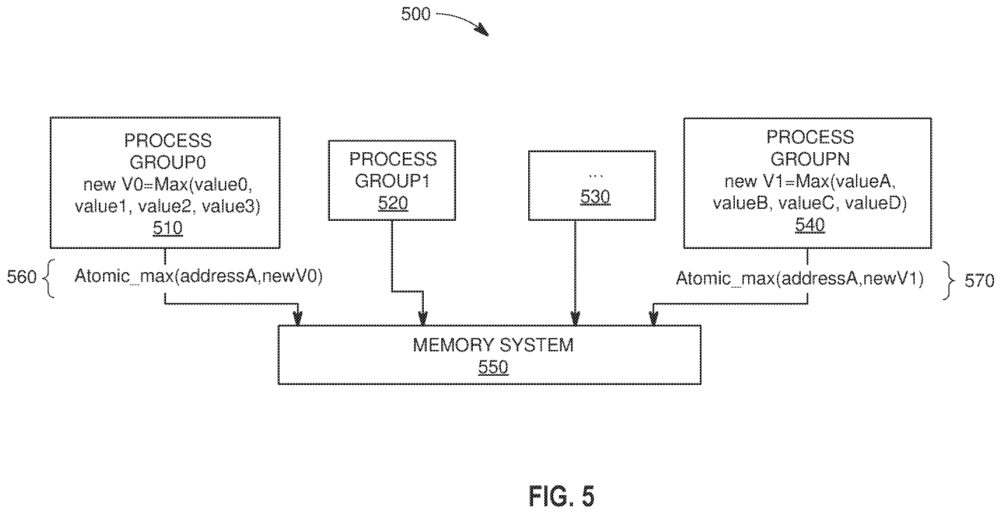

FIG. 5 illustrates a second example solution for atomic operations without data return 500. In one example, a first processing engine 510, a second processing engine 520, a third processing engine 530 and a fourth processing engine 540 access a shared memory 550. In one example, the first processing engine 510 executes a first single atomic operation without data return 560 using a first hardware-computed operation value. In one example, the fourth processing engine 540 executes a second single atomic operation without data return 570 using a second hardware-computed operation value. In this example, the first single atomic operation avoids a data collision and thus operates in a more efficient manner (i.e., faster performance). In this example, the second single atomic operation avoids a data collision and thus operates in a more efficient manner (i.e., faster performance).

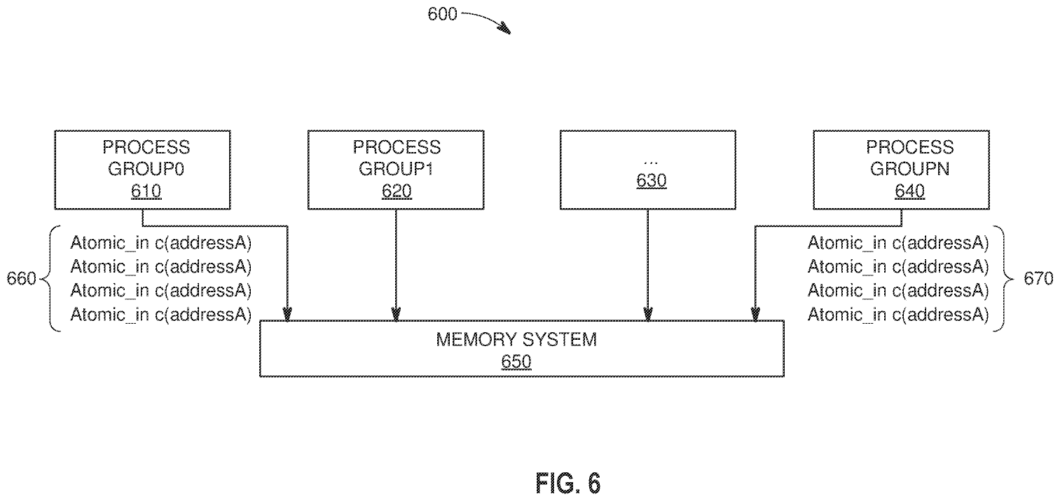

FIG. 6 illustrates a first example solution for atomic operations with data return 600. In one example, a first processing engine 610, a second processing engine 620, a third processing engine 630 and a fourth processing engine 640 access a shared memory 650. In one example, the first processing engine 610 executes a first plurality of atomic operations with data return 660. In one example, the fourth processing engine 640 executes a second plurality of atomic operations with data return 670. In this example, the first plurality of atomic operations needs to access a same shared memory location (i.e., addressA) such that individual atomic operations of the first plurality of atomic operations need to avoid a data collision and thus operate in a serialized manner which results in a performance bottleneck (i.e., slower performance). In this example, the second plurality of atomic operations needs to access the same shared memory location (i.e., addressA) such that individual atomic operations of the second plurality of atomic operations need to avoid a data collision and thus operate in a serialized manner which also results in a performance bottleneck.

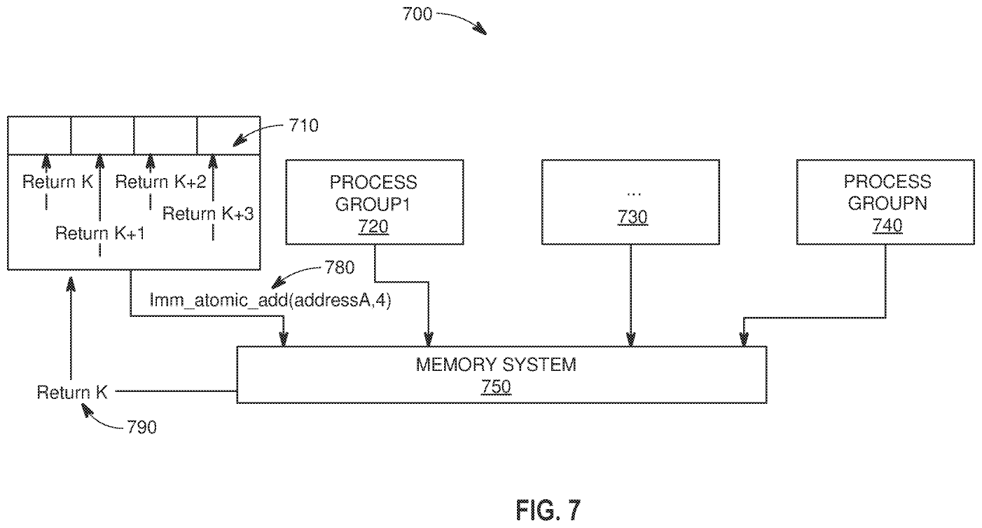

FIG. 7 illustrates a second example solution for atomic operations with data return 700. In one example, a first processing engine 710, a second processing engine 720, a third processing engine 730 and a fourth processing engine 740 access a shared memory 750. In one example, the first processing engine 710 executes a first single atomic operation with data return 780 using a first hardware-computed operation value. In one example, the first processing engine 710 receives a first return data value K 790 from the shared memory 750. In one example, the first processing engine 710 successively offsets the first return data value K to generate a first plurality of offsetted return data values. In this example, the first single atomic operation avoids a data collision and thus operates in a more efficient manner (i.e., faster performance).

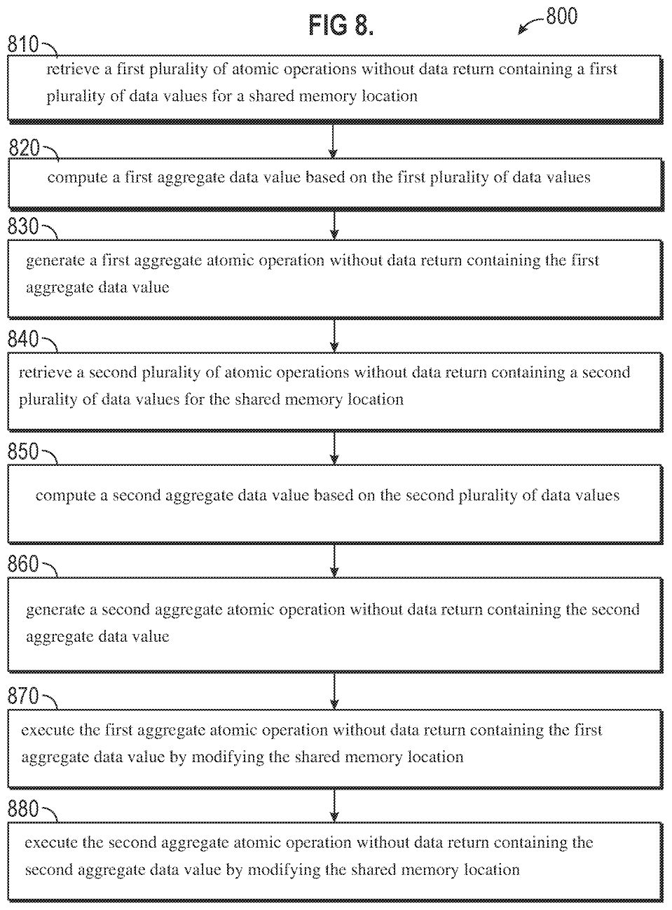

FIG. 8 illustrates an example flow diagram 800 for atomic operations without data return. In block 810, retrieve a first plurality of atomic operations without data return containing a first plurality of data values for a shared memory location. That is, a first plurality of atomic operations is retrieved. In one example, the first plurality of atomic operations without data return contains an address specifying the shared memory location. In one example, the first plurality of atomic operations includes atomic logical operations (e.g., AND, OR, XOR, etc.). In one example, the first plurality of atomic operations includes atomic compare/write operations. In one example, the first plurality of atomic operations includes atomic arithmetic operations (e.g., ADD, etc.). In one example, the first plurality of atomic operations includes atomic extrema operations (e.g., MAX. MIN, etc.). In one example, the retrieving is performed by a first plurality of processing engines. In one example, a modem retrieves the first plurality of atomic operations.

In block 820, compute a first aggregate data value based on the first plurality of data values of the first plurality of atomic operations without data return. That is, a first aggregate data value is computed. In one example, the computing is performed by the first plurality of processing engines. In one example, an aggregator, located with the GPU, computes the first aggregate data value. In one example, the aggregator is a specialized processing module which performs operations without usage of the shared memory. For example, the aggregator may use local registers for data retention or processor state maintenance (e.g., instruction count maintenance).

In block 830, generate a first aggregate atomic operation without data return containing the first aggregate data value. That is, a first aggregate atomic operation is generated. In one example, the issuing is performed by the first plurality of processing engines. In one example, an aggregator, located with the GPU, generates the first aggregate atomic operation. In one example, the aggregator is a specialized processing module which performs operations without usage of the shared memory. For example, the aggregator may use local registers for data retention or processor state maintenance (e.g., instruction count maintenance).

In block 840, retrieve a second plurality of atomic operations without data return containing a second plurality of data values for the shared memory location. That is, a second plurality of atomic operations is retrieved. In one example, the second plurality of atomic operations without data return contains an address specifying the shared memory location. In one example, the second plurality of atomic operations includes atomic logical operations (e.g., AND, OR, XOR, etc.). In one example, the second plurality of atomic operations includes atomic compare/write operations. In one example, the second plurality of atomic operations includes atomic arithmetic operations (e.g., ADD, etc.). In one example, the second plurality of atomic operations includes atomic extrema operations (e.g., MAX, MIN, etc.). In one example, the retrieving is performed by a second plurality of processing engines. In one example, a modem retrieves the second plurality of atomic operations.

In block 850, compute a second aggregate data value based on the second plurality of data values of the second plurality of atomic operations without data return. That is, a second aggregate data value is computed. In one example, the computing is performed by the second plurality of processing engines.

In block 860, generate a second aggregate atomic operation without data return containing the second aggregate data value. That is, a second aggregate atomic operation is generated. In one example, the issuing is performed by the second plurality of processing engines.

In block 870, execute the first aggregate atomic operation without data return containing the first aggregate data value by modifying the shared memory location. That is, the first aggregate atomic operation is executed. In one example, the execution is performed by the shared memory and the first plurality of processing engines.

In block 880, execute the second aggregate atomic operation without data return containing the second aggregate data value by modifying the shared memory location. That is, the second aggregate atomic operation is executed. In one example, the execution is performed by the shared memory and the second plurality of processing engines.

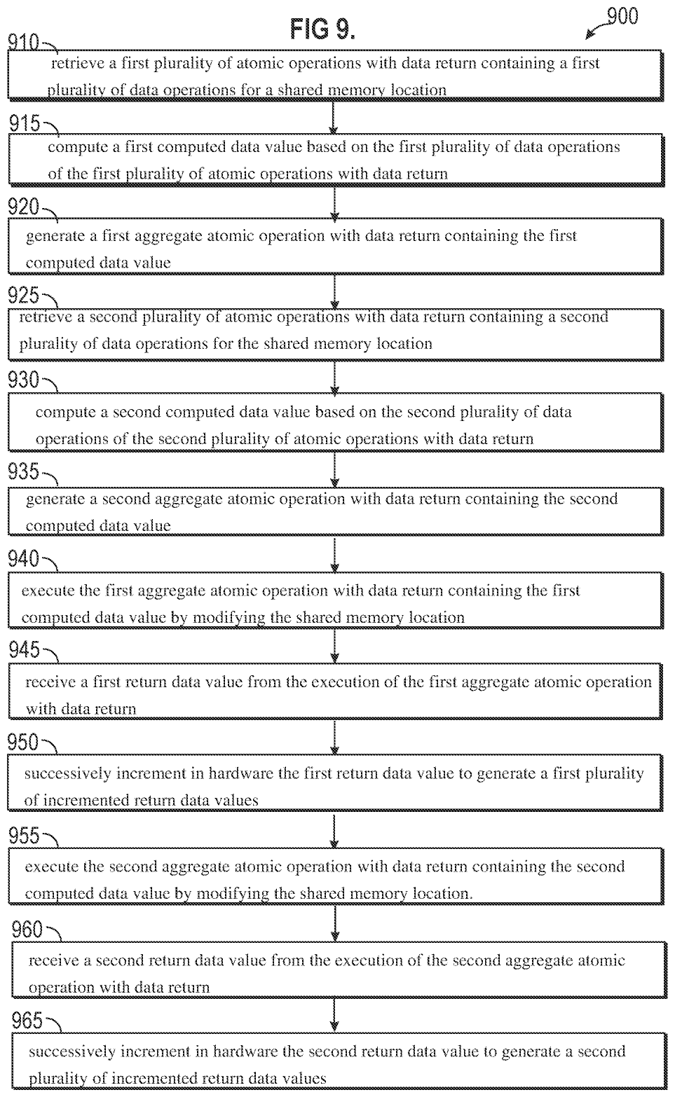

FIG. 9 illustrates an example flow diagram 900 for atomic operations with data return. In block 910, retrieve a first plurality of atomic operations with data return containing a first plurality of data operations for a shared memory location. That is, a first plurality of atomic operations is retrieved. In one example, the first plurality of atomic operations with data return contains an address specifying the shared memory location. In one example, the retrieving is performed by a first plurality of processing engines. In one example, a modem retrieves the first plurality of atomic operations.

In block 915, compute a first computed data value based on the first plurality of data operations of the first plurality of atomic operations with data return. That is, a first computed data value is computed. In one example, the first plurality of atomic operations includes atomic allocation operations (e.g., increment, etc.). In one example, the first plurality of atomic operations includes atomic consume operations (e.g., decrement, etc.). In one example, the computing is performed by the first plurality of processing engines. In one example, an aggregator, located with the GPU, computes the first computed data value. In one example, the aggregator is a specialized processing module which performs operations without usage of the shared memory. For example, the aggregator may use local registers for data retention or processor state maintenance (e.g., instruction count maintenance).

In block 920, generate a first aggregate atomic operation with data return containing the first computed data value. That is, a first aggregate atomic operation is generated. In one example, the issuing is performed by the first plurality of processing engines. In one example, an aggregator, located with the GPU, generates the first aggregate atomic operation. In one example, the aggregator is a specialized processing module which performs operations without usage of the shared memory. For example, the aggregator may use local registers for data retention or processor state maintenance (e.g., instruction count maintenance).

In clock 925, retrieve a second plurality of atomic operations with data return containing a second plurality of data operations for the shared memory location. That is, a second plurality of atomic operations is retrieved. In one example, the second plurality of atomic operations with data return contains an address specifying the shared memory location. In one example. the retrieving is performed by a second plurality of processing engines. In one example, a modem retrieves the second plurality of atomic operations.

In block 930, compute a second computed data value based on the second plurality of data operations of the second plurality of atomic operations with data return. That is, a second computed data value is computed. In one example, the second plurality of atomic operations includes atomic consume operations (e.g., decrement, etc.). In one example, the computing is performed by the second plurality of processing engines. In one example, an aggregator, located with the GPU, computes the second computed data value. In one example, the aggregator is a specialized processing module which performs operations without usage of the shared memory. For example, the aggregator may use local registers for data retention or processor state maintenance (e.g., instruction count maintenance).

In block 935, generate a second aggregate atomic operation with data return containing the second computed data value. That is, a second aggregate atomic operation is generated. In one example, the issuing is performed by the second plurality of processing engines. In one example, an aggregator, located with the GPU, generates the second aggregate atomic operation. In one example, the aggregator is a specialized processing module which performs operations without usage of the shared memory. For example, the aggregator may use local registers for data retention or processor state maintenance (e.g., instruction count maintenance).

In block 940, execute the first aggregate atomic operation with data return containing the first computed data value by modifying the shared memory location. That is, the first aggregate atomic operation is executed. In one example, the execution is performed by the shared memory and the first plurality of processing engines.

In block 945, receive a first return data value from the execution of the first aggregate atomic operation with data return. That is, a first return data value is received. In one example, the execution is performed by the first plurality of processing engines. In one example, a modem receives the first return data value.

In block 950, successively offset in hardware the first return data value to generate a first plurality of offsetted return data values. That is, the first return data value is successively offsetted to generate a first plurality of offsetted return data values. In one example, the offsetting is performed by the first plurality of processing engines.

In block 955, execute the second aggregate atomic operation with data return containing the second computed data value by modifying the shared memory location. That is, the second aggregate atomic operation is executed. In one example, the execution is performed by the shared memory and the second plurality of processing engines.

In block 960, receive a second return data value from the execution of the second aggregate atomic operation with data return. That is, a second return data value is received. In one example, the execution is performed by the second plurality of processing engines. In one example, a modem receives the second return data value.

In block 965, successively offset in hardware the second return data value to generate a second plurality of offsetted return data values. That is, the second return data value is successively offsetted to generate a second plurality of offsetted return data values. In one example, the offsetting is performed by the second plurality of processing engines.

In one aspect, one or more of the steps for providing information processing in FIGS. 8 & 9 may be executed by one or more processors which may include hardware, software, firmware, etc. The one or more processors, for example, may be used to execute software or firmware needed to perform the steps in the flow diagrams of FIGS. 8 & 9. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus for implementing information processing, the apparatus comprising:
a databus;
a memory system coupled to the databus; and
a graphics processing unit (GPU) coupled to the memory system and the databus, wherein the GPU is configured to do the following:
retrieve a first plurality of atomic operations containing a first plurality of data values for a shared memory location;
compute a first aggregate data value based on the first plurality of data values; and
generate a first aggregate atomic operation containing the first aggregate data value.

2. The apparatus of claim 1, wherein the GPU includes an aggregator, wherein the aggregator is configured to compute the first aggregate data value and to generate the first aggregate atomic operation.

3. The apparatus of claim 1, wherein the GPU is further configured to execute the first aggregate atomic operation containing the first aggregate data value by modifying the shared memory location.

4. The apparatus of claim 3, wherein the GPU is further configured to receive a first return data value from execution of the first aggregate atomic operation with data return.

5. The apparatus of claim 4, wherein the GPU is further configured to successively offset the first return data value to generate a first plurality of offsetted return data values.

6. The apparatus of claim 5, further comprising:
a display processing unit (DPU) coupled to the databus; and
a video display coupled to the DPU and the databus, wherein the video display is configured to display the first return data value and/or the first plurality of offsetted return data values.

7. The apparatus of claim 6 therein the GPU includes an aggregator, wherein the aggregator is configured to compute the first aggregate data value and to generate the first aggregate atomic operation.

8. The apparatus of claim 5, wherein the GPU is further configured to:
retrieve a second plurality of atomic operations containing a second plurality of data values for the shared memory location;
compute a second aggregate data value based on the second plurality of data values; and
generate a second aggregate atomic operation containing the second aggregate data value.

9. The apparatus of claim 8, wherein the GPU is further configured to:
receive a second return data value from the executing of the second aggregate atomic operation with data return; and
successively offset the second return data value to generate a second plurality of offsetted return data values.

10. The apparatus of claim 9, wherein the memory system comprises a memory unit and a cache memory.

11. A method for implementing information processing, the method comprising:
retrieving a first plurality of atomic operations containing a first plurality of data values for a shared memory location;
computing a first aggregate data value based on the first plurality of data values; and
generating a first aggregate atomic operation containing the first aggregate data value.

12. The method of claim 11, further comprising retrieving a second plurality of atomic operations containing a second plurality of data values for the shared memory location.

13. The method of claim 12, further comprising computing a second aggregate data value based on the second plurality of data values.

14. The method of claim 13, further comprising generating a second aggregate atomic operation containing the second aggregate data value.

15. The method of claim 14, further comprising executing the first aggregate atomic operation containing the first aggregate data value by modifying the shared memory location.

16. The method of claim 15, further comprising executing the second aggregate atomic operation containing the second aggregate data value by modifying the shared memory location.

17. The method of claim 16, further comprising receiving a first return data value from the executing of the first aggregate atomic operation with data return.

18. The method of claim 17, further comprising successively offsetting the first return data value to generate a first plurality of offsetted return data values.

19. The method of claim 18, further comprising receiving a second return data value from the executing of the second aggregate atomic operation with data return.

20. The method of claim 19, further comprising successively offsetting the second return data value to generate a second plurality of offsetted return data values.

21. The method of claim 11, further comprising executing the first aggregate atomic operation containing the first aggregate data value by modifying the shared memory location.

22. The method of claim 21 further comprising receiving a first return data value from execution of the first aggregate atomic operation with data return.

23. The method of claim 22, further comprising successively offsetting the first return data value to generate a first plurality of offsetted return data values.

24 An apparatus for information processing, the apparatus comprising:
means for retrieving a first plurality of atomic operations containing a first plurality of data values for a shared memory location;
means for computing a first aggregate data value based on the first plurality of data values; and
means for generating a first aggregate atomic operation containing the first aggregate data value.

25. The apparatus of claim 24, further comprising:
means for retrieving a second plurality of atomic operations containing a second plurality of data values for the shared memory location;
means for computing a second aggregate data value based on the second plurality of data values; and
means for generating a second aggregate atomic operation containing the second aggregate data value.

26. The apparatus of claim 25, further comprising:
means for executing the first aggregate atomic operation containing the first aggregate data value by modifying the shared memory location; and
means for executing the second aggregate atomic operation containing the second aggregate data value by modifying the shared memory location.

27. The apparatus of claim 26, further comprising:
means for receiving a first return data value from the executing of the first aggregate atomic operation with data return; and
means for successively offsetting the first return data value to generate a first plurality of offsetted return data values.

28. The apparatus of claim 27, further comprising:
means for receiving a second return data value from the executing of the second aggregate atomic operation with data return; and
means for successively offsetting the second return data value to generate a second plurality of offsetted return data values.

29. A non-transitory computer-readable medium storing computer executable code, operable on a device comprising at least one processor and at least one memory coupled to the at least one processor, wherein the at least one processor is configured to implement information processing, the computer executable code comprising:
instructions for causing a computer to retrieve a first plurality of atomic operations containing a first plurality of data values for a shared memory location;
instructions for causing the computer to compute a first aggregate data value based on the first plurality of data values; and
instructions for causing the computer to generate a first aggregate atomic operation containing the first aggregate data value.

30. The non-transitory computer-readable medium of claim 29, further comprising instructions for causing the computer to:
execute the first aggregate atomic operation containing the first aggregate data value by modifying the shared memory location;
receive a first return data value from the execution of the first aggregate atomic operation with data return; and
successively offset the first return data value to generate a first plurality of offsetted return data values.
